(19) United States
(12) Patent Application Publication
(10) Pub. No.: US 2011/0129658 A1
(43) Pub. Date: Jun. 2, 2011

(54) Transparent Conductive Laminate

(76) Inventors: Wun-Wei HU, Tainan City (TW); Chun-Ping Chan, Kaohsiung City (TW); Kuang-Rong Lee, Tainan City (TW)

(21) Appl. No.: 12/791,024

(22) Filed: Jun. 1, 2010

(30) Foreign Application Priority Data
Aug. 25, 2009 (TW) 098128529

(51) Int. Cl. B32B 7/02; B32B 9/00

(52) U.S. Cl. 428/220; 428/697

(57) ABSTRACT

A transparent conductive laminate includes a transparent substrate, a first transparent conductive film formed on the transparent substrate, and a second transparent conductive film formed on a surface of the first transparent conductive film opposite to the transparent substrate. The first transparent conductive film includes a material selected from an oxide of indium, an oxide of zinc, an oxide of tin, and combinations thereof. The second transparent conductive film includes diindium trioxide (In₂O₃) and titanium dioxide (TiO₂).

### CROSS-REFERENCE TO RELATED APPLICATION

This application claims priority of Taiwanese application no. 098128529, filed on Aug. 25, 2009.

### BACKGROUND OF THE INVENTION

1. Field of the Invention

This invention relates to a laminate, more particularly to a transparent conductive laminate.

2. Description of the Related Art

Since indium tin oxide (ITO) is electrically conductive and possesses a relatively high transmittance, it is widely used in transparent conductive laminates of touch panels, light, emitting diodes, solar batteries, and so on. However, ITO still has problems attributed to the relatively high crystallization temperature (above 160° C.) thereof.

For example, the problem with ITO, when ITO is used in a transparent conductive laminate of a touch panel, is described in the following.

A transparent conductive laminate of a touch panel includes a transparent substrate and an ITO film formed on the substrate. For the touch panel, the substrate should be flexible, and is usually a plastic substrate. The plastic substrate has poor heat-resistance, and an upper limit value of its heat-tolerant temperature range is about 160° C., and thus, the ITO film cannot be coated and annealed at a temperature above 160° C. Consequently, the ITO film thus formed is amorphous and has a less dense structure with plenty of defects. Such amorphous ITO film does not have a mechanical strength sufficient to tolerate the pressure caused by the user's surface contact.

A transparent conductive laminate for a touch panel including a crystalline ITO film is disclosed in JP 2008-41364. In this patent, the crystalline ITO film used in the transparent conductive laminate is formed on a transparent substrate by reactive sputtering method and includes crystalline indium tin oxide containing more than 50% of crystals. Particularly, the crystalline ITO film is made from a low tin oxide-content ITO material composed of 95 wt % of In₂O₃ and 5 wt % of SnO₂ and crystallized by heat treatment at 150° C. JP 2008-71531 discloses another transparent conductive laminate including a crystalline ITO film. In this patent, the transparent conductive laminate includes a transparent substrate and two crystalline. ITO films sequentially formed on the transparent substrate. The SnO₂ contents of the two ITO films are controlled, for example, one ITO film containing 95 wt % of In₂O₃ and 5 wt % of SnO₂ and the other ITO film containing 90 wt % of In₂O₃ and 10 wt % of SnO₂, so that the two films can be sufficiently crystallized by a heat treatment at a temperature of 150° C. Although the crystalline ITO films of these two patents can be crystallized at about 150° C., the cost of manufacture is relatively high due to complicated processes or preparation conditions and restrictive manufacturing equipments.

On the other hand, an indium titanium oxide material, one kind of materials of oxides of indium, has been used in the technical field relevant to a transistor or a liquid crystal display. For example, a transparent conductive film made of the indium titanium oxide material is usually formed on a glass substrate that has good humidity resistance. The indium titanium oxide material generally includes a relatively high content of In₂O₃ and traces of TiO₂ and other oxides and can be crystallized at about 150° C. However, such material has poor humidity resistance, i.e., poor weatherability.

After conducting an intense research, the inventors of the present application conceived application of the indium titanium oxide material to the transparent conductive film of a touch panel if the poor humidity resistance of such material can be improved.

### SUMMARY OF THE INVENTION

Therefore, an object of the present invention is to provide a transparent'conductive laminate that can be formed under nonrestrictive treatment conditions, that can be crystallized at a relatively low temperature (150° C.) to have a required mechanical strength for a touch panel, and that also has improved weatherability (humidity resistance).

Accordingly, a transparent conductive laminate of this invention comprises a transparent substrate, a first transparent conductive film formed on the transparent substrate, and a second transparent conductive film formed on a surface of the first transparent conductive film opposite to the transparent substrate. The first transparent conductive film includes a material selected from the group consisting of an oxide of indium, an oxide of zinc, an oxide of tin, and combinations thereof. The second transparent conductive film includes diindium trioxide (In₂O₃) and titanium dioxide (TiO₂).

### BRIEF DESCRIPTION OF THE DRAWING

Other features and advantages of the present invention will become apparent in the following detailed description of the preferred embodiment of the invention, with reference to the accompanying drawing, in which:

FIG. 1 illustrates a transparent conductive laminate according to the present invention.

### DETAILED DESCRIPTION OF THE PREFERRED EMBODIMENT

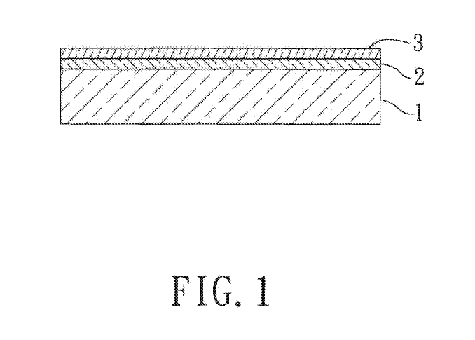

Referring to FIG. 1, a transparent conductive laminate according to the present invention includes a transparent substrate 1, a first transparent conductive film 2 formed on the transparent substrate 1, and a second transparent conductive film 3 formed on a surface of the first transparent conductive film 2 opposite to the transparent substrate 1.

The transparent substrate 1 in this embodiment is flexible and is preferably made of polyethylene terephthalate (PET), polycarbonate (PC), polyethylene (PE), etc. More preferably, the substrate 1 is made from PET.

The first transparent conductive film 2 may be made of any material as long as such material is transparent, conductive and possesses good humidity resistance, for example, an oxide of indium, an oxide of zinc, an oxide of tin, or combinations thereof. The oxide of indium means any indium oxide selectively doped with other elements, and the oxide of zinc and the oxide of tin have similar meanings. Preferably, the first transparent conductive film 2 is made from indium tin oxide (ITO).

The second transparent conductive film 3 is made from an indium titanium oxide material, which includes diindium trioxide (In₂O₃) and titanium dioxide (TiO₂) and is transparent and conductive. Preferably, the amount of diindium trioxide (In₂O₃) in the second transparent conductive film 3 ranges from 98 wt % to 99 wt %, and the remainder is titanium dioxide (TiO₂) and traces of other metal oxides.

Preferably, a total electrical resistance of the first and second transparent conductive films 2, 3 ranges from 50 Ω/mm²˜600 Ω/mm². Since the electrical resistance will be reduced with the increase of the thickness of the conductive film, a total thickness of the first and second transparent conductive films 2, 3 preferably ranges from 10 nm to 140 nm.

### EXAMPLES

This invention will now be described with reference to the following examples.

### Example 1

A transparent conductive laminate of Example 1 is made as follows. A transparent substrate having a thickness of 125 μm and made of polyethylene terephthalate (PET) was prepared. A first transparent conductive film of 4 μm was formed on a surface of the PET substrate by vacuum sputtering and used a sintered material of ITO (In₂O₃ 90%-SnO₂ 10%). When conducting the sputtering of the first transparent conductive film, the sputtering head is controlled at a temperature ranging from 80° C. to 150° C. in 2×10⁻³ torr, while the PET substrate is maintained near room temperature.

Then, a second transparent conductive film of 15 μm was formed on the first transparent conductive film by vacuum sputtering and used a sintered material of InTiO (In₂O₃ 98.99%). When conducting the sputtering of the second transparent conductive film, the sputtering head is controlled at a temperature ranging from 80° C. to 150° C. in 2×10⁻³ torr, while the PET substrate is maintained near room temperature.

After the first and second transparent conductive films were formed in that order on the PET substrate, these two films were annealed at 150° C. for 90 minutes to form the transparent conductive laminate.

### Example 2 and Comparative Examples 1 and 2

A transparent conductive laminate of Example 2 was made in a manner similar to that of Example 1 except that the thicknesses of the first and second transparent conductive films are different, as shown in Table 1. The transparent conductive laminates in Comparative Examples 1 and 2 were made in a manner similar to that of Example 1 except that only one of the first and second transparent conductive films was formed in a thickness of 17 μm in each of the Comparative Examples.

Mechanical strength and humidity resistance of each of the transparent conductive laminates of Examples 1-2 and Comparative Examples 1-2 were evaluated by an acid test and a weatherability test, respectively. Since, for a transparent conductive laminate, the conductivity thereof is the most important factor, the two tests were respectively evaluated based on variation of sheet resistance of the conductive film(s) of each of the laminates caused by an acid and the test conditions of temperature and humidity.

Acid Test

When a conductive film is crystalline, the arrangement of atoms is regular and the defects are reduced, and thus, the conductive film has a rigid structure and possesses better acid resistance (i.e., better mechanical strength). Accordingly, in this case, the degree of crystallization and the mechanical strength for the transparent conductive laminates of the Examples and Comparative Examples were evaluated by the acid test.

The acid test was conducted by measuring an initial sheet resistance (R₀) of each of the transparent conductive laminates before dipping in an acid (1N HCl), dipping each of the laminates in the acid for 10 minutes, followed by measuring a final sheet resistance (R₁) of each of the laminates after being dipped in the acid. Each of the sheet resistances (R₀ and R₁) is an average value obtained from 25 measurement points predetermined on the conductive film(s) of each of the laminates.

A variation ratio of the sheet resistance of each of the laminates is defined by R₁/R₀ and is used for evaluating the acid resistance (i.e., the degree of the crystallization and the mechanical strength). The smaller the variation ratio of the laminate, the better the strength of the laminate. The results are shown in Table 1.

Weatherability Test

The weatherability test was conducted by (a) measuring an initial sheet resistance (R₀) of each of the transparent conductive laminates before step (b), (b) disposing the laminates in an atmosphere at 85° C. and 85% RH for 72 hours, and (c) measuring a final sheet resistance (R₂) of each of the laminates after step (b). Each of the sheet resistances (R₀ and R₂) is an average value obtained from 25 measurement points predetermined on the conductive film(s) of each of the laminates.

The weatherability for each of the laminates was evaluated by a variation ratio of sheet resistance in the weatherability test and by comparing uniformity of sheet resistance before and after the weatherability test. The results are shown in Table 1.

The variation ratio of sheet resistance in the weatherability test is defined by R₂/R₀. The lower the variation ratio, the better the weatherability of the laminate.

The uniformity of sheet resistance is defined as follows:

$$Uniformity of sheet resistance = \frac{{R}_{max} - {R}_{min}}{{R}_{max} + {R}_{min}} \times 100 \%$$

where means the maximum sheet resistance among the 25 measurement points of each of the laminates; and Rₘᵢₙ Means the minimum sheet resistance among the 25 measurement points of each of the laminates.

The lower the variance of the uniformity of sheet resistance before and after the weatherability test, the better the weatherability of the laminate.

TABLE 1

| | First | Second | | Weatherability test | | |
|---|---|---|---|---|---|---|
| | transparent | transparent | Acid | | Uniformity | Uniformity |
| | conductive | conductive | test | | (before | (after |
| Sample | film (nm) | film (nm) | R₁/R₀ | R₂/R₀ | test) | test) |
| Ex. 1 | 4 | 15 | 1.07 | 1.1 | 1.63% | 3.59% |
| Ex. 2 | 7 | 12 | 1.05 | 1.0 | 2.17% | 2.76% |
| Comp. Ex. 1 | 17 | 0 | ∞ | 1.1 | 2.22% | 4.45% |
| Comp. Ex. 2 | 0 | 17 | 1.13 | 1.4 | 2.95% | 14.95% |

Concerning the result of the acid test, because the sheet resistance of the first transparent conductive film of the laminate of Comparative Example 1 cannot be measured, the variation ratio (R₁/R₀) is represented by ∞. Thus, it can be expected that the laminate of Comparative Example 1 has a relatively low degree of crystallization in structure and poor mechanical strength.

Moreover, from the result of the acid test shown in Table 1, it is apparent that the mechanical strength of the laminates in Examples 1 and 2 are better than that of the laminate of Comparative Example 2. Since each of the laminates in Examples 1 and 2 includes the first transparent conductive film having a crystallization temperature above 150° C. and the second transparent conductive-film having a crystallization temperature at about 150° C., and since the laminate in Comparative Example 2 includes only one transparent conductive film made from the same material as that for making the second transparent conductive film of the laminates of Examples 1 and 2, it is expected that the first transparent conductive film is likely to be induced to crystallize at 150° C. during annealing.

Concerning the result of the weatherability test, the laminate of Comparative Example 2, which includes the second transparent conductive film only, has a variation ratio (R₂/R₀) larger than 1.2, and the uniformity in sheet resistance thereof varies to a greater extent after the weatherability test. On the contrary, the laminates of Examples 1 and 2 possess better weatherability based on the results of the variation ratio (R₂/R₀) and the uniformity in sheet resistance before and after the test.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A transparent conductive laminate, comprising a transparent substrate, a first transparent conductive film formed on said transparent substrate, and a second transparent conductive film formed on a surface of said first transparent conductive film opposite to said transparent substrate, wherein:
said first transparent conductive film includes a material selected from the group consisting of an oxide of indium, an oxide of zinc, an oxide of tin, and combinations thereof; and
said second transparent conductive film includes diindium trioxide (In₂O₃) and titanium dioxide (TiO₂).

2. The transparent conductive laminate of claim 1, wherein the amount of diindium trioxide (In₂O₃) in said second transparent conductive film ranges from 98 wt % to 99 wt %.

3. The transparent conductive laminate of claim 1, wherein the material in said first transparent conductive film is indium tin oxide (ITO).

4. The transparent conductive laminate of claim 1, wherein a total thickness of said first and second transparent conductive films ranges from 10 nm to 190 nm.
